(19) United States
(12) Patent Application Publication
(10) Pub. No.: US 2012/0258679 A1
(43) Pub. Date: Oct. 11, 2012

(54) APPARATUS AND METHOD FOR REDUCING INTERFERENCE SIGNAL IN RECEIVER

(75) Inventor: Dong Pil CHANG, Daejeon (KR)

(73) Assignee: Electronics and Telecommunications Research Institute, Daejeon (KR)

(21) Appl. No.: 13/441,086

(22) Filed: Apr. 6, 2012

(30) Foreign Application Priority Data
Apr. 7, 2011 (KR) 10-2011-0032322
Apr. 4, 2012 (KR) 10-2012-0035034

(51) Int. Cl. H04B 1/10; H04B 1/06

(52) U.S. Cl. 455/233.1; 455/305; 455/235.1

(57) ABSTRACT

An interference signal reducing apparatus of a wireless communication system divides a signal that is input through a receiving antenna into a first signal and a second signal having a magnitude larger than that of the first signal and detects a frequency and a magnitude of an interference signal from the first signal, thereby generating an interference removal signal and then adds an interference removal signal to the signal that is input through the receiving antenna and thus reduces a magnitude of the interference signal.

### CROSS-REFERENCE TO RELATED APPLICATION

This application claims priority to and the benefit of Korean Patent Application Nos. 10-2011-0032322 and 10-2012-0035034 filed in the Korean Intellectual Property Office on Apr. 7, 2011 and Apr. 4, 2012, the entire contents of which are incorporated herein by reference.

### BACKGROUND OF THE INVENTION

(a) Field of the Invention

The present invention relates to a method and apparatus for reducing an interference signal in a receiver of a wireless communication system.

(b) Description of the Related Art

In a receiver that receives a weak wireless signal, as in a conventional satellite navigation receiver, when an intentional or accidental jamming (disturbance) signal is input to an antenna thereof, receiving sensitivity of the receiver may be weakened or a signal processing error may occur in the receiver. Such a phenomenon is generally represented as performance deterioration of a receiver by a jamming or interference signal.

Particularly, in a satellite navigation receiver, because power of a navigation signal in which a receiving antenna receives is about −130 dBm/2 MHz and the navigation signal is a very weak signal, receiving sensitivity is generally degraded even by a continuous wave (CW) interference signal of about −100 dBm.

In order to overcome performance deterioration of the receiver due to such a jamming signal, many techniques are used, but a method and technology that can completely solve so far performance deterioration of the receiver do scarcely exist, and various anti-jamming techniques may be complexly used, but as the receiver becomes complicated and a volume thereof increases, various anti-jamming techniques may not apply to a small terminal.

Anti-jamming technology that is used for a satellite navigation receiver that has been known so far includes technology that adjusts a receiving pattern of the antenna and technology that excludes a jamming signal in a signal processing area.

Anti-jamming technology may include, for example, a method of reducing transmission of a jamming signal to a receiver by reducing an antenna gain in an inflow direction of a jamming signal by adjusting an antenna beam pattern using a multiple antenna. This method is one of anti-jamming techniques that are performed in an RF terminal, requires several antenna elements, and should use an additional anti-jamming device that is connected to each antenna and thus an antenna is complicated and has a volume large enough to form a system with only an antenna itself.

### SUMMARY OF THE INVENTION

The present invention has been made in an effort to provide a method and apparatus for reducing an interference signal in a receiver having advantages of minimizing performance degradation of the receiver due to a jamming signal that is injected into the receiver.

An exemplary embodiment of the present invention provides an interference signal reducing apparatus. The interference signal reducing apparatus includes a first signal division unit, a detection unit, and a summation unit. The first signal division unit divides a signal that is input through a receiving antenna of a wireless communication system into first and second signals. The detection unit detects a frequency and a magnitude of an interference signal from the first signal and generates an interference removal signal using the detected frequency and magnitude. The summation unit adds the interference removal signal to a signal that is input through the receiving antenna and outputs the added signal.

The interference removal signal may have the same magnitude and frequency as those of the interference signal and have a phase difference of 180° from the interference signal.

A magnitude of the first signal may be smaller than that of the second signal.

The interference signal reducing apparatus may further include a second signal division unit, and the second signal division unit may divide a partial signal of an output signal of the summation unit and output the partial signal to the detection unit, wherein the detection unit may compare the partial signal and the first signal and change at least one of a phase and a magnitude of the interference removal signal.

The summation unit may operate the second signal division unit, if a magnitude of the output signal is larger than or equal to a reference level.

The wireless communication system may include an automatic gain adjustor that automatically adjusts a gain according to a magnitude of an input signal, and the interference signal reducing apparatus may be positioned between the receiving antenna and the automatic gain adjustor.

The wireless communication system may include an amplifier that amplifies a signal that is input through the receiving antenna, and the interference signal reducing apparatus may be positioned at a front end or a rear end of the amplifier.

The wireless communication system may include an amplifier that amplifies a signal that is input through the receiving antenna, and the first signal division unit and the detection unit may be positioned at a rear end of the amplifier, and the summation unit may be positioned at a front end of the amplifier.

Another embodiment of the present invention provides a method of reducing an interference signal from a signal that is input through a receiving antenna in an interference signal reducing apparatus of a wireless communication system. The method includes dividing the signal that is input through the receiving antenna into a first signal and a second signal having a magnitude larger than that of the first signal; detecting a frequency and a magnitude of an interference signal from the first signal; generating an interference removal signal using the frequency and the magnitude of the interference signal; and reducing a magnitude of an interference signal in the signal that is input through the receiving antenna using the interference removal signal.

The interference removal signal may have the same magnitude and frequency as those of the interference signal and have a phase difference of 180° from the interference signal, and the reducing of a magnitude may include adding the interference removal signal to the signal that is input through the receiving antenna.

The method may further include performing the reducing of a magnitude by changing at least one of a frequency and a magnitude of the interference removal signal after the reducing of a magnitude. The performing of the reducing of a magnitude may be repeated until a magnitude of an output signal of the interference signal reducing apparatus becomes smaller than a reference level.

The performing of the reducing of a magnitude may include dividing a partial signal of an output signal of the interference signal reducing apparatus; and changing at least one of a frequency and a magnitude of the interference removal signal through comparison of the partial signal and the first signal.

According to an exemplary embodiment of the present invention, as sensitivity of a receiver of a wireless communication system such as a satellite navigation receiver is weakened in an intentional jamming environment or an accidental interference signal environment, a phenomenon in which the receiver erroneously operates can be substantially solved.

### BRIEF DESCRIPTION OF THE DRAWINGS

FIG. 1 is a diagram illustrating an example of a receiver of a wireless communication system according to an exemplary embodiment of the present invention.

FIG. 2 is a diagram conceptually illustrating a method of reducing an interference signal in a receiver according to an exemplary embodiment of the present invention.

FIG. 3 is a block diagram illustrating a configuration of an interference signal reducing apparatus according to a first exemplary embodiment of the present invention.

FIG. 4 is a flowchart illustrating operation of the interference signal reducing apparatus that is shown in FIG. 3.

FIGS. 5 and 6 are diagrams illustrating an interference signal reducing apparatus according to second and third exemplary embodiments, respectively of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification and claims, unless explicitly described to the contrary, the word “comprise” and variations such as “comprises” or “comprising”, will be understood to imply the inclusion of stated elements but not the exclusion of any other elements.

Hereinafter, a method and apparatus for reducing an interference signal in a receiver according to an exemplary embodiment of the present invention will be described in detail with reference to the drawings.

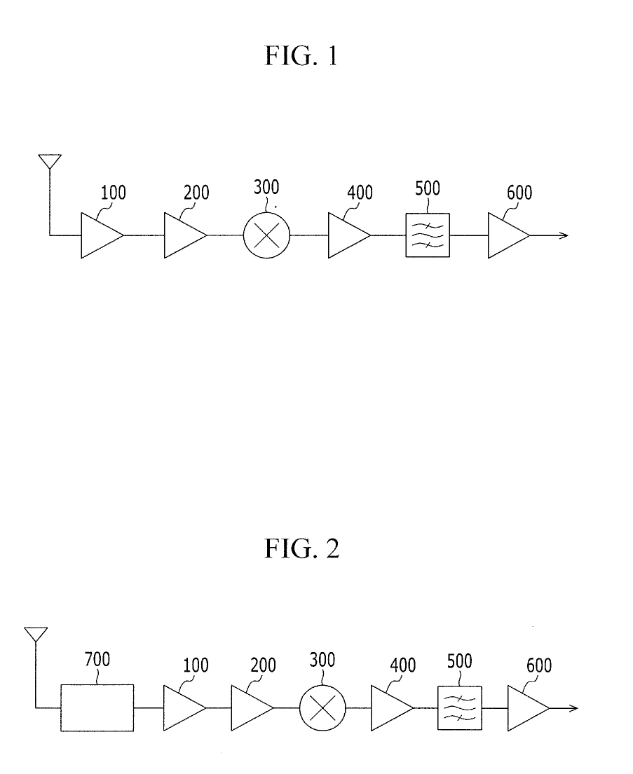

FIG. 1 is a diagram illustrating an example of a receiver of a wireless communication system according to an exemplary embodiment of the present invention.

Referring to FIG. 1, a receiver of a wireless communication system includes at least one amplifier 100, 200, and 600, at least one frequency converter 300, at least one automatic gain adjustor 400, and a band pass filter 500.

The amplifiers 100, 200, and 600 amplify an input signal. The amplifier 100 amplifies a signal that is input through a receiving antenna, and the amplifier 200 amplifies again a signal that is amplified in the amplifier 100. The amplifier 200 amplifies a signal that passes through the band pass filter 500.

The frequency converter 300 converts a frequency of a signal that is amplified in the amplifier 200 and outputs the signal to the automatic gain adjustor 400. The frequency converter 300 synthesizes a frequency for frequency conversion of a partial oscillator (not shown) to the signal that is amplified in the amplifier 200, thereby converting the signal to a baseband or an intermediate frequency band.

The automatic gain adjustor 400 automatically adjusts a gain according to a magnitude of an input signal, thereby uniformly controlling a magnitude of the input signal. The automatic gain adjustor 400 may be formed in a form of a variable gain amplifier.

The band pass filter 500 selects and passes through a necessary characteristic frequency band in an output signal of the automatic gain adjustor 400.

In such a receiver, for example, when a jamming (disturbance) signal of a level higher than that of a desired signal is input to the automatic gain adjustor 400, the automatic gain adjustor 400 operates to be an optimum gain of the receiver in a level of the jamming signal. Therefore, as a level of the jamming signal increases, a gain of the receiver decreases, and therefore an amplification gain of a desired signal decreases and thus receiving sensitivity is degraded. Moreover, when a magnitude of a jamming signal is large, before the automatic gain adjustor 400 operates, the amplifiers 100 and 200 constituting the receiver arrives at a saturation state and thus a phenomenon in which that the amplifiers 100 and 200 do not amplify a signal may occur and even in this case, receiving sensitivity of the receiver is deteriorated.

A jamming signal is a kind of an interference signal, and hereinafter, signals, except for a desired signal are referred to as an interference signal.

FIG. 2 is a diagram conceptually illustrating a method of reducing an interference signal in a receiver according to an exemplary embodiment of the present invention.

As shown in FIG. 2, the receiver may further include an interference signal reducing apparatus 700. The interference signal reducing apparatus 700 may be positioned between the receiving antenna and the amplifier 100.

The interference signal reducing apparatus 700 reduces an interference signal from a signal that is input through the receiving antenna and outputs the signal to the amplifier 100. Thereby, the automatic gain adjustor 400 may not respond to the interference signal.

Specifically, the interference signal reducing apparatus 700 detects a frequency and a magnitude of an interference signal from a signal that is input through the receiving antenna and generates an interference removal signal having the same magnitude and frequency as those of the detected interference signal, but having a phase difference of 180° from the detected interference signal. Next, when the interference signal reducing apparatus 700 adds the interference removal signal to a signal that is input to the receiver, interference signal reducing apparatus 700 reduces an interference signal from the signal that is input to the receiver.

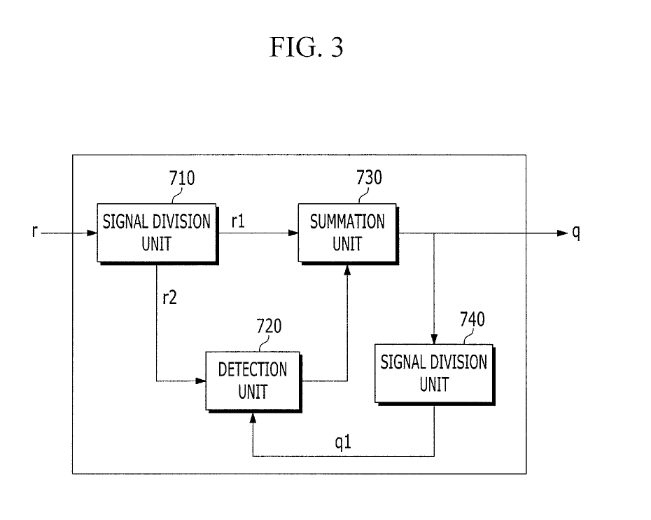

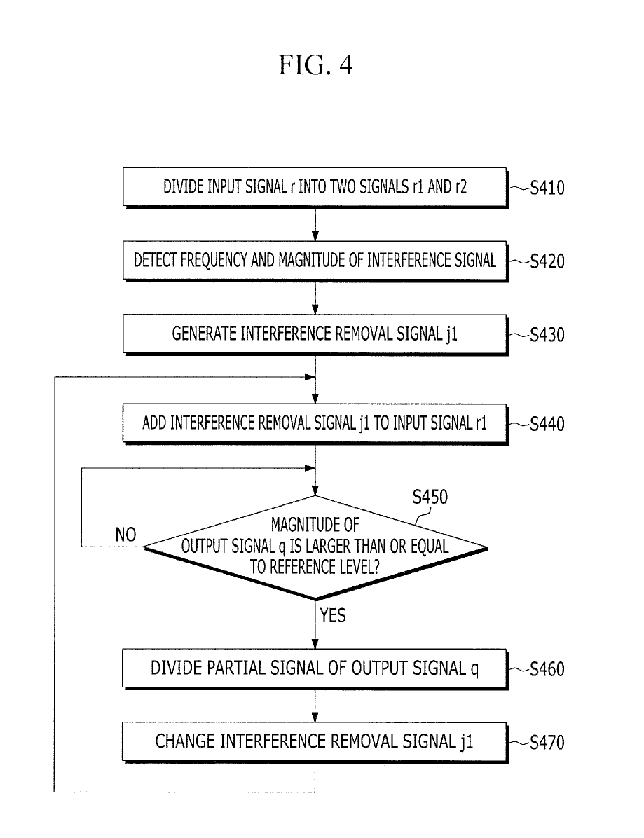

FIG. 3 is a block diagram illustrating a configuration of an interference signal reducing apparatus according to a first exemplary embodiment of the present invention, FIG. 4 is a flowchart illustrating operation of the interference signal reducing apparatus that is shown in FIG. 3.

Referring to FIG. 3, the interference signal reducing apparatus 700 includes signal division units 710 and 740, a detection unit 720, and a summation unit 730.

The signal division unit 710 divides a signal r that is input through the receiving antenna into two signals r1 and r2 (S410), and outputs the signal r1 to the summation unit 730 and outputs the signal r2 to the detection unit 720. In this case, the signal r2 is used for detecting a magnitude and a frequency of an interference signal. Therefore, when a magnitude of the signal r2 is much smaller than that of the signal r1, degradation of a noise index and deterioration of receiving sensitivity of the receiver can be prevented.

The detection unit 720 detects a frequency and a magnitude of an interference signal from the signal r2 that is input from the signal division unit 710 (S420), and generates an interference removal signal j1 using the frequency and magnitude of the detected interference signal (S430). That is, the detection unit 720 generates an interference removal signal j1 having a phase difference of 180° from the detected interference signal while having the same magnitude and frequency as those of the detected interference signal and outputs the generated interference removal signal to the summation unit 730.

The summation unit 730 adds the interference removal signal j1 to the signal r1 that is input from the signal division unit 710 and outputs the signal to the amplifier 100 (S440).

In this way, when the interference removal signal j1 is added to the signal r1 that is input from the signal division unit 710, the interference removal signal j1 has the same magnitude as that of the interference signal and has a phase difference of 180° from the interference signal and thus an interference signal is removed from the signal r1 or a magnitude of an interference signal is reduced.

The interference signal may not be completely removed by the summation unit 730. Therefore, the summation unit 730 determines whether a magnitude of an output signal q of the summation unit 730 is larger than or equal to a predetermined reference level (S450). If a magnitude of an output signal q is larger than or equal to a predetermined reference level, it is determined that an interference signal is included in the signal r1, and the reference level may be set to a level in which the interference signal does not damage signal processing sensitivity of the receiver.

If a magnitude of an interference signal is larger than or equal to a predetermined reference level, the signal division unit 740 divides a partial signal of an output signal q of the summation unit 730 and outputs the partial signal to the detection unit 720 (S460). That is, if a magnitude of an output signal q is larger than or equal to a predetermined reference level, the summation unit 730 operates the signal division unit 740, and the signal division unit 740 divides a partial signal of the output signal q by the control of the summation unit 730.

When the detection unit 720 receives an input of a signal q1 from the signal division unit 740, the detection unit 720 compares the signal r2 and the signal q1, changes a frequency, a phase, and a magnitude of the interference removal signal j1 (S470), and outputs again the interference removal signal j1 to the summation unit 730.

Such an operation may be repeatedly performed until an interference signal is removed and a magnitude of an output signal q becomes a predetermined reference level or less.

According to generally known summation theory of an electrical signal, when two signals having the same frequency have the same magnitude and a phase difference of 180°, if two signals are synthesized, a magnitude of the synthesized signal becomes 0 and the signal is thus removed. Therefore, when an interference signal has a magnitude larger than that of a desired received signal or when a frequency of an interference signal is detected, a jamming signal can be removed with a method that is described with reference to FIG. 3.

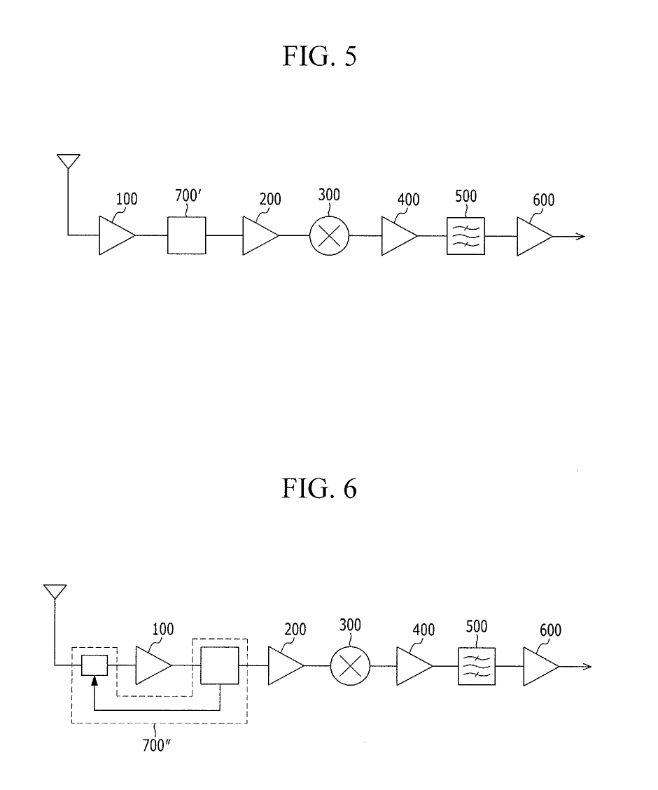

FIG. 5 is a diagram illustrating an interference signal reducing apparatus according to a second exemplary embodiment of the present invention.

Referring to FIG. 5, an interference signal reducing apparatus 700′ may be positioned at a rear end of the amplifier 100, unlike the first exemplary embodiment.

The interference signal reducing apparatus 700′ may reduces an interference signal from a signal that is amplified in the amplifier 100. This may be effective when magnitudes of a signal that is input to the receiver and the interference signal are small.

FIG. 6 is a diagram illustrating an interference signal reducing apparatus according to a third exemplary embodiment of the present invention.

Referring to FIG. 6, an interference signal reducing apparatus 700″ includes signal division units 710 and 740, a detection unit 720, and a summation unit 730, and the signal division units 710 and 740, the detection unit 720, and the summation unit 730 may be appropriately disposed at a front end and a rear end of the amplifier 100.

For example, the signal division unit 710 and the detection unit 720 may be disposed at a rear end of the amplifier 100, and the summation unit 730 and the signal division unit 740 may be disposed at a front end of the amplifier 100. That is, because the signal division unit 710 and the detection unit 720 are disposed at a rear end of the amplifier 100, the detection unit 720 generates an interference removal signal in an amplified signal of the amplifier 100, outputs the interference removal signal to the summation unit 730 that is disposed at a front end of the amplifier 100, reduces an interference signal from the summation unit 730, and outputs again the signal to the amplifier 100.

Thereby, even when magnitudes of a signal that is input to the receiver and an interference signal are small, the interference signal can be effectively reduced.

An exemplary embodiment of the present invention may be not only embodied through the above-described apparatus and/or method but also embodied through a program that executes a function corresponding to a configuration of the exemplary embodiment of the present invention or through a recording medium on which the program is recorded and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An interference signal reducing apparatus comprising:
a first signal division unit that divides a signal that is input through a receiving antenna of a wireless communication system into first and second signals;
a detection unit that detects a frequency and a magnitude of an interference signal from the first signal and that generates an interference removal signal using the detected frequency and magnitude; and
a summation unit that adds the interference removal signal to a signal that is input through the receiving antenna and that outputs the added signal.

2. The interference signal reducing apparatus of claim 1, wherein the interference removal signal has the same magnitude and frequency as those of the interference signal and has a phase difference of 180° from the interference signal.

3. The interference signal reducing apparatus of claim 2, wherein a magnitude of the first signal is smaller than that of the second signal.

4. The interference signal reducing apparatus of claim 2, further comprising a second signal division unit that divides a partial signal of an output signal of the summation unit and that outputs the partial signal to the detection unit,
wherein the detection unit compares the partial signal and the first signal and changes at least one of a phase and a magnitude of the interference removal signal.

5. The interference signal reducing apparatus of claim 4, wherein the summation unit operates the second signal division unit, if a magnitude of the output signal is larger than or equal to a reference level.

6. The interference signal reducing apparatus of claim 2, wherein the wireless communication system comprises an automatic gain adjustor that automatically adjusts a gain according to a magnitude of an input signal,
the interference signal reducing apparatus is positioned between the receiving antenna and the automatic gain adjustor.

7. The interference signal reducing apparatus of claim 2, wherein the wireless communication system comprises an amplifier that amplifies a signal that is input through the receiving antenna, and
the interference signal reducing apparatus is positioned at a front end or a rear end of the amplifier.

8. The interference signal reducing apparatus of claim 2, wherein the wireless communication system comprises an amplifier that amplifies a signal that is input through the receiving antenna, and
the first signal division unit and the detection unit are positioned at a rear end of the amplifier, and the summation unit is positioned at a front end of the amplifier.

9. A method of reducing an interference signal from a signal that is input through a receiving antenna in an interference signal reducing apparatus of a wireless communication system, the method comprising:
dividing the signal that is input through the receiving antenna into a first signal and a second signal having a magnitude larger than that of the first signal;
detecting a frequency and a magnitude of an interference signal from the first signal;
generating an interference removal signal using the frequency and the magnitude of the interference signal; and
reducing a magnitude of an interference signal in the signal that is input through the receiving antenna using the interference removal signal.

10. The method of claim 9, wherein the interference removal signal has the same magnitude and frequency as those of the interference signal and has a phase difference of 180° from the interference signal, and
the reducing of a magnitude comprises adding the interference removal signal to the signal that is input through the receiving antenna.

11. The method of claim 9, further comprising performing the reducing of a magnitude by changing at least one of a frequency and a magnitude of the interference removal signal after the reducing of a magnitude,
wherein the performing of the reducing of a magnitude is repeated until a magnitude of an output signal of the interference signal reducing apparatus becomes smaller than a reference level.

12. The method of claim 11, wherein the performing of the reducing of a magnitude comprises
dividing a partial signal of an output signal of the interference signal reducing apparatus; and
changing at least one of a frequency and a magnitude of the interference removal signal through comparison of the partial signal and the first signal.

13. The method of claim 9, wherein the wireless communication system comprises an automatic gain adjustor that automatically adjusts a gain according to a magnitude of the input signal, and
the interference signal reducing apparatus is positioned between the receiving antenna and the automatic gain adjustor.

14. The method of claim 9, wherein the wireless communication system comprises an amplifier that amplifies a signal that is input through the receiving antenna,
the dividing of the signal, the detecting of a frequency, and the generating of an interference removal signal are performed at a rear end of the amplifier, and
the reducing of a magnitude is performed at a front end of the amplifier.
